(19) United States
(12) Patent Application Publication
(10) Pub. No.: US 2026/0206926 A1
(43) Pub. Date: Jul. 23, 2026

(54) CONNECTING ASSEMBLY AND TELESCOPIC CONNECTING ROD ASSEMBLY AND WALKING AID AND TOILET ARMREST

(71) Applicant: Xinzhiyuan Medical Equipment (Guangdong) Co., Ltd., Foshan (CN)

(72) Inventors: Tianxi Wang, Foshan (CN); Xigen Huang, Foshan (CN); Yudan Huang, Foshan (CN); Zhongliang Liu, Foshan (CN)

(21) Appl. No.: 19/057,219

(22) Filed: Feb. 19, 2025

(30) Foreign Application Priority Data
Jan. 23, 2025 (CN) 2025201628929

(51) Int. Cl. A45B 9/00; A47K 17/02; F16B 7/10

(52) U.S. Cl. CPC A45B 9/00; A47K 17/026; F16B 7/10; A45B 2009/007; A45B 2200/05

(57) ABSTRACT

A connecting assembly, a telescopic connecting rod assembly, a walking aid and a toilet armrest, wherein the connecting assembly comprises a connecting member, a first locking handle and a second locking handle; an interior of the connecting member is provided with a connecting channel extending in a first direction; the first locking handle is provided with a first locking portion, the first locking handle is rotatably connected to the connecting member to drive the first locking portion to enter or leave the connecting channel; the second locking handle is provided with a second locking portion, the second locking handle is rotatably connected to the connecting member to drive the second locking portion to enter or leave the connecting channel. In the connecting assembly, telescopic connecting rod assembly, walking aid and the toilet armrest, connecting assembly is convenient to disassemble and install, thereby effectively improving the stability and user experience.

### 1. TECHNICAL FIELD

The invention relates to the technical field of connecting assemblies, and in particular to a connecting assembly, a telescopic connecting rod assembly, a walking aid and a toilet armrest.

### 2. BACKGROUND ART

In devices such as walking aids and toilet armrests, it is generally necessary to use a connecting assembly to connect two connecting rods. In existing connecting assemblies, bolts are commonly used to fix the two connecting rods together, which makes both disassembly and installation quite troublesome, resulting in a poor user experience.

### 3. SUMMARY OF THE INVENTION

The first object of the invention is to provide a connecting assembly, aiming to solve the problem of the troublesome assembly and disassembly of the existing connecting assemblies.

The second object of the invention is to provide a telescopic connecting rod assembly, aiming to solve the problem of the troublesome assembly and disassembly of the existing telescopic connecting rod assemblies.

The third object of the invention is to provide a walking aid, aiming to solve the problem of the troublesome assembly and disassembly of the existing walking aids.

The fourth object of the invention is to provide a toilet armrest, aiming to solve the problem of the troublesome assembly and disassembly of the existing toilet armrests.

To realize the above purposes, the invention adopts the following technical scheme:
in a first aspect, a connecting assembly is provided, comprising a connecting member, a first locking handle and a second locking handle;
an interior of the connecting member is provided with a connecting channel extending in a first direction;
the first locking handle is provided with a first locking portion, the first locking handle is rotatably connected to the connecting member to drive the first locking portion to enter or leave the connecting channel;
the second locking handle is provided with a second locking portion, the second locking handle is rotatably connected to the connecting member to drive the second locking portion to enter or leave the connecting channel.

Optionally, an inner wall of the connecting channel is provided with a limiting step, the limiting step divides the connecting channel into a first connecting channel and a second connecting channel, an inner diameter of the first connecting channel is smaller than that of the second connecting channel, so that the first locking portion can enter or leave the first connecting channel, and the second locking portion can enter or leave the second connecting channel.

Optionally, the connecting member is provided with a first locking hole, the first locking hole is in communication with the first connecting channel, the first locking portion can pass through the first locking hole and enter the first connecting channel.

Optionally, the connecting assembly further comprises a first rotating shaft, the first locking portion is rotatably connected to the connecting member via the first rotating shaft, and the first locking portion is an eccentric structure.

Optionally, a limiting protrusion is arranged on one side of the connecting member away from the first rotating shaft, and a locking groove is arranged on one end of the first locking handle away from the first rotating shaft, the locking groove can be snap-fitted to the limiting protrusion.

Optionally, the second locking handle is provided with a locking shaft, the second locking portion is rotatably connected to the second locking handle via the locking shaft, the connecting member is provided with a second locking hole, the second locking hole is communicated with the second connecting channel, the second locking portion can pass through the second locking hole and enter the second connecting channel.

Optionally, the connecting assembly further comprises a second rotating shaft and an elastic member, the second locking handle is rotatably connected to the connecting member via the second rotating shaft, the elastic member and the second locking portion are respectively located on two sides of the second rotating shaft, one end of the elastic member abuts against the connecting member, and the other end of the elastic member abuts against the second locking handle.

In a second aspect, a telescopic connecting rod assembly is provided, comprising a first connecting rod, a second connecting rod and the above connecting assembly, an outer diameter of the first connecting rod is smaller than an inner diameter of the second connecting rod, the first connecting rod is provided with a plurality of adjustment holes, the second connecting rod is provided with a positioning hole, the first connecting rod is inserted into the first connecting channel, the second connecting rod is inserted into the second connecting channel, the first connecting rod is inserted into the second connecting rod, the first locking portion can abut against the first connecting rod, and the second locking portion can pass through the second locking hole and the positioning hole and be inserted into one of the adjustment holes.

In a third aspect, a walking aid is provided, comprising a first connecting rod, a second connecting rod and the above connecting assembly, an outer diameter of the first connecting rod is smaller than an inner diameter of the second connecting rod, the first connecting rod is provided with a plurality of adjustment holes, the second connecting rod is provided with a positioning hole, the first connecting rod is inserted into the first connecting channel, the second connecting rod is inserted into the second connecting channel, the first connecting rod is inserted into the second connecting rod, the first locking portion can abut against the first connecting rod, and the second locking portion can pass through the second locking hole and the positioning hole and be inserted into one of the adjustment holes.

In a fourth aspect, a toilet armrest is provided, comprising a first connecting rod, a second connecting rod and the above connecting assembly, an outer diameter of the first connecting rod is smaller than an inner diameter of the second connecting rod, the first connecting rod is provided with a plurality of adjustment holes, the second connecting rod is provided with a positioning hole, the first connecting rod is inserted into the first connecting channel, the second connecting rod is inserted into the second connecting channel, the first connecting rod is inserted into the second connecting rod, the first locking portion can abut against the first connecting rod, and the second locking portion can pass through the second locking hole and the positioning hole and be inserted into one of the adjustment holes

Compared with the prior art, the invention has the following advantages:
1. In the connecting assembly provided by the invention, the connecting member is used to connect two connecting rods, the first locking handle can lock one of the connecting rods by rotating, and the second locking handle can lock the other connecting rod by rotating, which is very convenient for both disassembly and installation, and effectively improves the user experience.
2. The telescopic connecting rod assembly provided by the invention adopts the above connecting assembly, which is very convenient for both disassembly and installation, and effectively improves the stability and user experience.
3. The walking aid provided by the invention adopts the above connecting assembly, which is very convenient for both disassembly and installation, and effectively improves the stability and user experience.
4. The toilet armrest provided by the invention adopts the above connecting assembly, which is very convenient for both disassembly and installation, and effectively improves the stability and user experience.

### 4. BRIEF DESCRIPTION OF ACCOMPANYING DRAWINGS

In order to explain the technical schemes in the embodiments of the invention or prior art more clearly, the accompanying drawings needed to be used in the description of the embodiments or the prior art will be briefly introduced below. Obviously, the accompanying drawings in the following description are only are some embodiments of the invention. For those of ordinary skill in the art, other accompanying drawings can be obtained based on these accompanying drawings without exerting creative efforts.

FIG. 1 is a schematic diagram of the structures of the connecting assembly, the first connecting rod and the second connecting rod of the invention.

FIG. 2 is a schematic diagram of the internal structures of the connecting assembly, the first connecting rod and the second connecting rod of the invention.

FIG. 3 is an exploded schematic diagram of the connecting assembly, the first connecting rod and the second connecting rod of the invention.

In the figures: 1 connecting member, 11 first connecting channel, 12 second connecting channel, 13 limiting step, 14 first locking hole, 15 limiting protrusion, 16 second locking hole, 17 first positioning portion, 2 first locking handle, 21 first locking portion, 22 locking groove, 23 clearance hole, 3 second locking handle, 31 second locking portion, 32 locking shaft, 33 second positioning portion, 4 first rotating shaft, 5 second rotating shaft, 6 elastic member, 7 first connecting rod, 71 adjustment hole, 8 second connecting rod, 81 positioning hole.

### 5. SPECIFIC EMBODIMENT OF THE INVENTION

The technical schemes in the embodiments of the invention will be clearly and completely described. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

In the description of the invention, it should be understood that the orientation or positional relationship indicated by the terms “length”, “width”, “up”, “down”, “front”, “back”, “left”, “right”, “vertical”, “horizontal”, “top”, “bottom”, “inside”, “outside” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention.

In addition, the terms of “first”, “second” are only used for descriptive purposes, and should not be understood as indicating or implying relative importance or implying the number of indicated technical features. Therefore, the features defined with “first” or “second” may expressly or implicitly include one or more of the features.

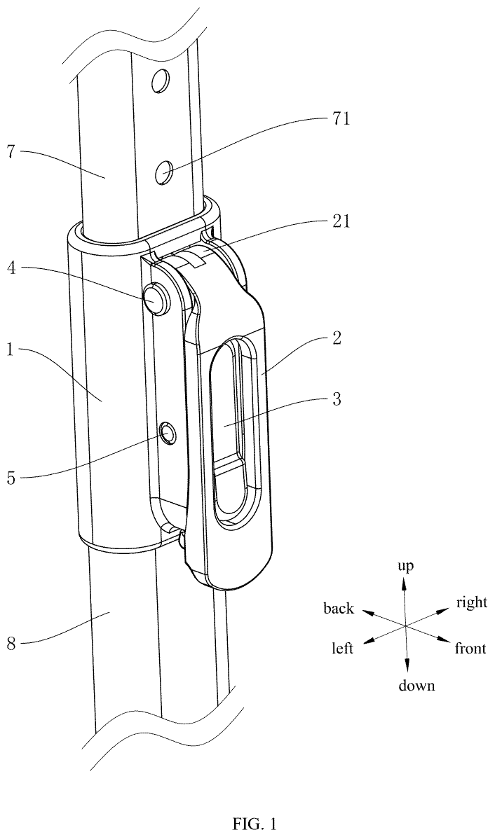

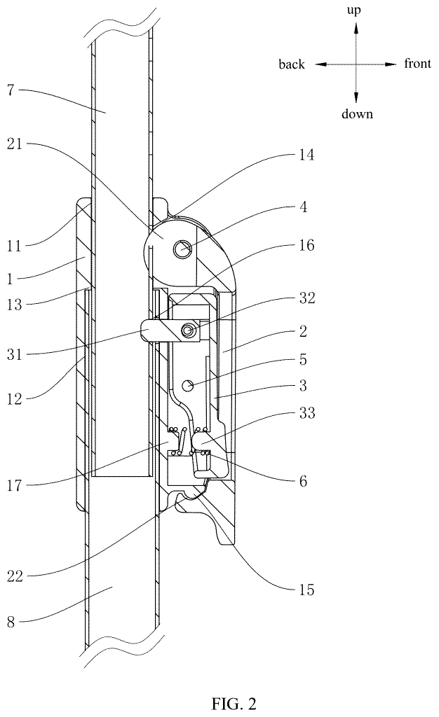

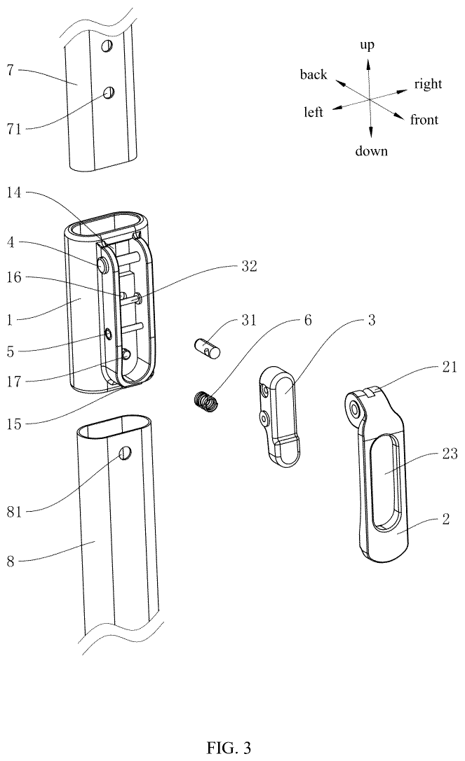

A connecting assembly, a telescopic connecting rod assembly, a walking aid and a toilet armrest are described in combination with FIG. 1 to 3.

As shown in FIG. 1 to 3, the invention provides a connecting assembly, comprising a connecting member 1, a first locking handle 2 and a second locking handle 3; an interior of the connecting member 1 is provided with a connecting channel extending in a first direction, wherein the first direction is an up-down direction; the first locking handle 2 is provided with a first locking portion 21, the first locking handle 2 is rotatably connected to the connecting member 1 to drive the first locking portion 21 to enter or leave the connecting channel; the second locking handle 3 is provided with a second locking portion 31, the second locking handle 3 is rotatably connected to the connecting member 1 to drive the second locking portion 31 to enter or leave the connecting channel.

Specifically, the connecting member 1 is used to connect two connecting rods, the first locking handle 2 can lock one of the connecting rods by rotating, and the second locking handle 3 can lock the other connecting rod by rotating, which is very convenient for both disassembly and installation, and effectively improves the user experience.

In some embodiments, the connecting member 1, the first locking handle 2 and the second locking handle 3 are all made of plastic, which have a certain deformation ability and a certain stability.

For the convenience of explanation, in this embodiment, each orientation is shown in FIG. 1.

In some embodiments, an inner wall of the connecting channel is provided with a limiting step 13, the limiting step 13 divides the connecting channel into a first connecting channel 11 and a second connecting channel 12, an inner diameter of the first connecting channel 11 is smaller than that of the second connecting channel 12, so that the first locking portion 21 can enter or leave the first connecting channel 11, and the second locking portion 31 can enter or leave the second connecting channel 12. Specifically, one connecting rod is inserted into the first connecting channel 11, the other connecting rod is inserted into the second connecting channel 12, the first locking portion 21 is used to lock one connecting rod, and the second locking portion 31 is used to lock the other connecting rod, so that the two connecting rods can be connected together more conveniently and quickly, and both disassembly and installation are very convenient.

In some embodiments, the connecting member 1 is provided with a first locking hole 14, the first locking hole 14 is in communication with the first connecting channel 11, the first locking portion 21 can pass through the first locking hole 14 and enter the first connecting channel 11. The first locking hole 14 is located at a front side of the connecting member 1, and the first locking portion 21 can pass through the first locking hole 14 into the first connecting channel 11 and abut against the surface of one of the connecting rods to prevent the connecting rod from leaving the first connecting channel 11, thereby completing the fixing of the connecting rod. When disassembling, the first locking handle 2 is rotated to make the first locking portion 21 leave the first connecting channel 11, and the connecting rod can be pulled out, thereby completing the disassembly of the connecting rod, which is very convenient for both disassembly and installation.

In some embodiments, the connecting assembly further comprises a first rotating shaft 4, the first locking portion 21 is rotatably connected to the connecting member 1 via the first rotating shaft 4, and the first locking portion 21 is an eccentric structure. Specifically, when the first locking portion 21 fixes the connecting rod, the first locking portion 21 can pass through the first locking hole 14 and enter the first connecting channel 11. When disassembling, when viewed from the left, the first locking handle 2 is turned counterclockwise, the first locking portion 21 will leave the first connecting channel 11, and the connecting rod can leave the first connecting channel 11, thereby completing the disassembly of the connecting rod, which is very convenient to operate.

In some embodiments, a limiting protrusion 15 is arranged on one side of the connecting member 1 away from the first rotating shaft 4, and a locking groove 22 is arranged on one end of the first locking handle 2 away from the first rotating shaft 4, the locking groove 22 can be snap-fitted to the limiting protrusion 15. Specifically, when it is needed to lock the connecting rod, the locking groove 22 is engaged with the limiting protrusion 15, which can prevent the first locking handle 2 from rotating itself, thereby improving stability during use.

In some embodiments, the second locking handle 3 is provided with a locking shaft 32, the second locking portion 31 is rotatably connected to the second locking handle 3 via the locking shaft 32, the connecting member 1 is provided with a second locking hole 16, the second locking hole 16 is communicated with the second connecting channel 12, the second locking portion 31 can pass through the second locking hole 16 and enter the second connecting channel 12. Specifically, the second locking hole 16 is located at a lower side of the first locking hole 14, the second locking portion 31 is located at an upper side of the second locking handle 3; the second locking member can pass through the second locking hole 16 and be plugged into the connection limit hole of the connecting rod, thereby completing the fixation of the connecting rod. When disassembling, according to the lever principle, the second locking member can be moved to drive the second locking portion 31 to leave the second connecting channel 12, and the connecting rod can be disassembled at this time, which is very convenient to operate.

In some embodiments, the connecting assembly further comprises a second rotating shaft 5, the second locking handle 3 is rotatably connected to the connecting member 1 via the second rotating shaft 5. By providing the second rotating shaft 5, the second locking member can be moved more conveniently.

In some embodiments, the connecting assembly further comprises an elastic member 6, the elastic member 6 and the second locking portion 31 are respectively located on two sides of the second rotating shaft 5, one end of the elastic member 6 abuts against the connecting member 1, and the other end of the elastic member 6 abuts against the second locking handle 3. Specifically, the connecting member 1 is provided with a first positioning portion 17, and the second locking handle 3 is provided with a second positioning portion 33. Two ends of the elastic member 6 are respectively sleeved on the first positioning portion 17 and the second positioning portion 33. According to the lever principle, when viewed from the left, the elastic member 6 can drive the second locking handle 3 to maintain a counterclockwise rotation trend, so that the second locking portion 31 can be more stably inserted into the connection limit hole of the connecting rod, thereby improving the stability during use.

In some embodiments, the elastic member 6 is a spring, which can better apply elastic force to the second locking handle 3.

In some embodiments, a clearance hole 23 is arranged in the middle of the first locking handle 2, and the second locking handle 3 is located in the middle of the clearance hole 23. The user can press the second locking handle 3 through the clearance hole 23, which makes the operation more convenient.

The invention also provides a telescopic connecting rod assembly, comprising a first connecting rod 7, a second connecting rod 8 and the connecting assembly according to any one of claims 2 to 7, wherein an outer diameter of the first connecting rod 7 is smaller than an inner diameter of the second connecting rod 8, the first connecting rod 7 is provided with a plurality of adjustment holes 71, the second connecting rod 8 is provided with a positioning hole 81, the first connecting rod 7 is inserted into the first connecting channel 11, the second connecting rod 8 is inserted into the second connecting channel 12, the first connecting rod 7 is inserted into the second connecting rod 8, the first locking portion 21 can abut against the first connecting rod 7, and the second locking portion 31 can pass through the second locking hole 16 and the positioning hole 81 and be inserted into one of the adjustment holes 71.

The invention also provides a walking aid, comprising a first connecting rod 7, a second connecting rod 8 and the connecting assembly according to any one of claims 2 to 7, wherein an outer diameter of the first connecting rod 7 is smaller than an inner diameter of the second connecting rod 8, the first connecting rod 7 is provided with a plurality of adjustment holes 71, the second connecting rod 8 is provided with a positioning hole 81, the first connecting rod 7 is inserted into the first connecting channel 11, the second connecting rod 8 is inserted into the second connecting channel 12, the first connecting rod 7 is inserted into the second connecting rod 8, the first locking portion 21 can abut against the first connecting rod 7, and the second locking portion 31 can pass through the second locking hole 16 and the positioning hole 81 and be inserted into one of the adjustment holes 71.

The invention also provides a toilet armrest, comprising a first connecting rod 7, a second connecting rod 8 and the connecting assembly according to any one of claims 2 to 7, wherein an outer diameter of the first connecting rod 7 is smaller than an inner diameter of the second connecting rod 8, the first connecting rod 7 is provided with a plurality of adjustment holes 71, the second connecting rod 8 is provided with a positioning hole 81, the first connecting rod 7 is inserted into the first connecting channel 11, the second connecting rod 8 is inserted into the second connecting channel 12, the first connecting rod 7 is inserted into the second connecting rod 8, the first locking portion 21 can abut against the first connecting rod 7, and the second locking portion 31 can pass through the second locking hole 16 and the positioning hole 81 and be inserted into one of the adjustment holes 71.

The above description is only an embodiment of the invention, and does not limit the patent scope of the invention. Any equivalent structure or equivalent process transformation made using the contents of the invention specification, or directly or indirectly applied in other related technical fields, are also included in the patent protection scope of the invention.

1. A connecting assembly, comprising a connecting member, a first locking handle and a second locking handle;
an interior of the connecting member is provided with a connecting channel extending in a first direction;
the first locking handle is provided with a first locking portion, the first locking handle is rotatably connected to the connecting member to drive the first locking portion to enter or leave the connecting channel;
the second locking handle is provided with a second locking portion, the second locking handle is rotatably connected to the connecting member to drive the second locking portion to enter or leave the connecting channel.

2. The connecting assembly of claim 1, wherein an inner wall of the connecting channel is provided with a limiting step, the limiting step divides the connecting channel into a first connecting channel and a second connecting channel, an inner diameter of the first connecting channel is smaller than that of the second connecting channel, so that the first locking portion can enter or leave the first connecting channel, and the second locking portion can enter or leave the second connecting channel.

3. The connecting assembly of claim 2, wherein the connecting member is provided with a first locking hole, the first locking hole is in communication with the first connecting channel, the first locking portion can pass through the first locking hole and enter the first connecting channel.

4. The connecting assembly of claim 3, wherein the connecting assembly further comprises a first rotating shaft, the first locking portion is rotatably connected to the connecting member via the first rotating shaft, and the first locking portion is an eccentric structure.

5. The connecting assembly of claim 4, wherein a limiting protrusion is arranged on one side of the connecting member away from the first rotating shaft, and a locking groove is arranged on one end of the first locking handle away from the first rotating shaft, the locking groove can be snap-fitted to the limiting protrusion.

6. The connecting assembly of claim 5, wherein the second locking handle is provided with a locking shaft, the second locking portion is rotatably connected to the second locking handle via the locking shaft, the connecting member is provided with a second locking hole, the second locking hole is communicated with the second connecting channel, the second locking portion can pass through the second locking hole and enter the second connecting channel.

7. The connecting assembly of claim 6, wherein the connecting assembly further comprises a second rotating shaft and an elastic member, the second locking handle is rotatably connected to the connecting member via the second rotating shaft, the elastic member and the second locking portion are respectively located on two sides of the second rotating shaft, one end of the elastic member abuts against the connecting member, and the other end of the elastic member abuts against the second locking handle.

8. A telescopic connecting rod assembly, comprising a first connecting rod, a second connecting rod and the connecting assembly according to claim 2, wherein an outer diameter of the first connecting rod is smaller than an inner diameter of the second connecting rod, the first connecting rod is provided with a plurality of adjustment holes, the second connecting rod is provided with a positioning hole, the first connecting rod is inserted into the first connecting channel, the second connecting rod is inserted into the second connecting channel, the first connecting rod is inserted into the second connecting rod, the first locking portion can abut against the first connecting rod, and the second locking portion can pass through the second locking hole and the positioning hole and be inserted into one of the adjustment holes.

9. A walking aid, comprising a first connecting rod, a second connecting rod and the connecting assembly according to claim 2, wherein an outer diameter of the first connecting rod is smaller than an inner diameter of the second connecting rod, the first connecting rod is provided with a plurality of adjustment holes, the second connecting rod is provided with a positioning hole, the first connecting rod is inserted into the first connecting channel, the second connecting rod is inserted into the second connecting channel, the first connecting rod is inserted into the second connecting rod, the first locking portion can abut against the first connecting rod, and the second locking portion can pass through the second locking hole and the positioning hole and be inserted into one of the adjustment holes.

10. A toilet armrest, comprising a first connecting rod, a second connecting rod and the connecting assembly according to claim 2, wherein an outer diameter of the first connecting rod is smaller than an inner diameter of the second connecting rod, the first connecting rod is provided with a plurality of adjustment holes, the second connecting rod is provided with a positioning hole, the first connecting rod is inserted into the first connecting channel, the second connecting rod is inserted into the second connecting channel, the first connecting rod is inserted into the second connecting rod, the first locking portion can abut against the first connecting rod, and the second locking portion can pass through the second locking hole and the positioning hole and be inserted into one of the adjustment holes.
